(19) United States
(12) Patent Application Publication
(10) Pub. No.: US 2017/0256040 A1
(43) Pub. Date: Sep. 7, 2017

(54) Self-Image Augmentation

(71) Applicant: Brightway Vision Ltd., Haifa (IL)

(72) Inventor: Yoav GRAUER, Haifa (IL)

(73) Assignee: Brightway Vision Ltd., Haifa (IL)

(21) Appl. No.: 15/506,882

(22) PCT Filed: Aug. 20, 2015
(86) PCT No.: PCT/IL2015/050838

§ 371 Date: Feb. 27, 2017

(30) Foreign Application Priority Data
Aug. 31, 2014 (IL) 234396

(51) Int. Cl. G06T 5/50; G06T 3/40; H04N 5/232

(52) U.S. Cl. CPC G06T 5/50; H04N 5/23293; G06T 3/40; G06T 2207/20221

(57) ABSTRACT

Method and system for image augmentation. A captured image of a user in a scene includes a user portion and a background portion with partial scene features cut off at the image frame borders. A first set of imaging parameters is obtained, including the position and orientation of the camera when capturing the image. A background-image is retrieved in accordance with the obtained imaging parameters, from a database that includes imagery of real-world environments. The retrieved background-image is captured at a second set of imaging parameters such that the background-image includes supplementary scene features located beyond the image frame borders of the captured image and supplementing information for the partial scene features of the background portion. An updated image is generated in which the user appears relative to a background that includes the supplementary scene features, by image fusion of the captured image with the background-image.

### FIELD OF THE INVENTION

The present invention generally relates to image processing and image enhancement.

### BACKGROUND OF THE INVENTION

A self-image, colloquially referred to as a “selfie”, is a photograph taken by an individual of oneself, where the photograph may also depict other people as well as background scenery. Typically, a selfie is captured by a hand-held camera, such as a digital camera embedded within a smartphone, where the person holds the camera at arm's length with the camera lens facing towards him/her. In such a scenario, the background content that is visible in the self-image is restricted, due to the limited distance between the person and camera arising from the physical constraint of the length of the person's arm. For example, at popular tourist locations, where taking selfies is a common activity, the selfie may not actually include certain landmarks or environmental features of interest present at that location, which the person may want to appear in the self-image to provide a reliable and accurate memento of the experience. At such tourist locations, the person may be alone or may not want to provide his camera to a stranger to take a photo at a larger focal distance, and thus the person is limited to the option of a selfie. The particular characteristics of the selfie, such as the amount of background features that eventually appear visible in the image, is influenced by various parameters relating to the particular person and the environment. Such parameters include: the length of the person's arm; the relative angle of the camera position; the particular camera settings (e.g., shutter speed, aperture size, focal length, resolution); the time of day and month of year, as well as the weather and climate conditions, when the selfie was taken (which may affect lighting and visibility), etc. These parameters may also affect the clarity of the features and landmarks that do appear in the selfie photo, which may not be perceived clearly and accurately. Thus, it may be helpful to enhance the appearance of such features and landmarks in the self-image (or at least portions thereof). Further additionally, there may be situations where the existing real-world landmarks and features are not preferable from the individual's standpoint, such as due to the environmental conditions or other factors. For example, a particular desired landmark may be closed to renovations or obscured due to temporary construction work and the like, preventing the landmark from being clearly depicted in the selfie (even if the selfie is optimally captured). For a further example, the person may only be capable of visiting the location with the landmark during a time when there are poor imaging conditions available, such as during a snowstorm or late at night, preventing the landmark from being captured clearly in a selfie photo. Also, some features or landmarks may interfere with or obstruct the view of other features or landmarks in the surroundings. The person may also want to obtain different views or perspectives of the features or landmarks, such as selfie photos that include the landmark from different positions, heights and viewing angles, and/or at different resolutions or magnification levels. This would be a difficult undertaking even if the selfie photo is actually captured by another person, or by placing the camera on a nearby surface and using a timer mechanism to activate the camera. The selfie image may also be subject to vibrations or mechanical instability of the person's hand when the image is captured, which is difficult to completely prevent, leading to blurriness and out-of-focus images. It is also challenging for the individual to properly position and align the camera in such a way as to include all of the particular features of interest that he/she may want to appear in the selfie photo.

U.S. Pat. No. 8,330,831 to Steinberg et al, entitled “Method of gathering visual meta data using a reference image”, is directed to a digital image processing technique that gathers visual meta data using a reference image. A main image and one or more reference images are captured on a hand-held or otherwise portable or spatial or temporal performance-based image-capture device. The reference images are analyzed based on predefined criteria in comparison to the main image. Based on the analyzing, supplemental meta data are created and added to the main image at a digital data storage location.

U.S. Pat. No. 8,682,097 to Steinberg et al, entitled “Digital image enhancement with reference images”, is directed to a digital image processing technique for correcting visual imperfections using a reference image. A main image and one or more reference images having a temporal or spatial overlap and/or proximity with the original image are captured. Device information, image data and/or meta-data are analyzed of the reference images relating to a defect in the main image. The device corrects the defects based on the information, image data and/or meta-data to create an enhanced version of the main image.

U.S. Pat. No. 8,427,520 to Rosenberg et al, entitled “Removing a self image from a continuous presence video image”, is directed to a method and apparatus for identifying a self image embedded in a continuous presence (CP) video image frame, such as in a videoconferencing system. An endpoint of the videoconference identifies an embedded marker in the CP video image frame, such as a coded vertical line and coded horizontal line, and calculates a location of a self image in the CP video image frame. The embedded markers may be inserted by the endpoint of a multipoint control unit serving the endpoint. The self image may be replaced with other video data, including an alternate video image from another endpoint or a background color.

U.S. Pat. No. 8,675,084 to Bolton et al, entitled “Systems and methods for remote camera control”, is directed to remotely controlling a camera in a portable media device, to enable remotely capturing a still photo or video image. An accessory can control the camera by exchanging a set of commands with the device, and can register with the device to receive notifications regarding the camera state. The accessory may remotely start a camera application program if a notification that the camera is inactive is received. The accessory may change the camera mode, may instruct the camera to capture a still image, or to start or stop video recording. The accessory may also receive the captured image for preview, or may instruct the device about the deposition of the image (e.g., save or delete). The accessory may periodically send an image capture command to enable the camera to take a series of still images during a predetermined time or over a given time period.

U.S. Patent Application No. 2012/0224787 to et al, entitled “Systems and methods for image capturing”, is directed to image enhancement intended to compensate for non-ideal imaging conditions, such as weather conditions that result in partial or complete obscuring of the imaged scene. A first image includes a subject at a first position in the scene. Scene information is determined from the first image, including a first field of view and a first capture location where the first image was captured. A second image of the scene is acquired from a repository, based on the scene information. The second image has a second field of view similar to the first field of view, and a second capture location similar to the first capture location. The lighting parameters of the subject image are adjusted based on the lighting parameters of the second image. A combined image is then generated, which includes at least part of the second image and the adjusted image of the subject at a position in the scene similar to the first position in the scene.

### SUMMARY OF THE INVENTION

In accordance with one aspect of the present invention, there is thus provided a method for image augmentation. The method includes the procedure of capturing at least one image of a user in a scene with at least one camera at a first set of imaging parameters, such that the captured image includes a user portion and a background portion with partial scene features cut off at the image frame borders due to limitations of the first set of imaging parameters. The method further includes the procedure of obtaining at least a portion of the first set of imaging parameters, the obtained imaging parameters including at least the position and orientation of the camera when capturing the image. The method further includes the procedure of retrieving at least one background-image in accordance with the obtained imaging parameters, from a database that includes imagery of real-world environments. The retrieved background-image is captured at a second set of imaging parameters, different from the first set of imaging parameters, such that the background-image includes supplementary scene features located beyond the image frame borders of the captured image and supplementing information for the partial scene features of the background portion. The method further includes the procedure of generating an updated image in which the user appears relative to a background that includes at least the supplementary scene features, by image fusion of the captured image with the background-image. The method may further include the procedure of transmitting the updated image or displaying the updated image. The position and orientation of the camera may be obtained from a location measurement unit coupled with the camera. The position and orientation of the camera may be obtained from a location measurement unit coupled with the camera. The position and orientation of the camera may be obtained from a location measurement unit coupled with the camera. The obtained imaging parameters may further include: physical characteristics of the user; the field of view of the camera; the distance between the camera and the user; the distance between the camera and at least one feature in the scene; the depth of focus of the camera; the focal length of the camera; the f-number of the camera; and/or intrinsic parameters and settings of the camera. The method may further include obtaining environmental conditions of the captured image, and the procedure of retrieving at least one background-image may include retrieving the background-image further in accordance with the environmental conditions. The environmental conditions may include: lighting conditions in the scene; weather or climate conditions in the scene; the time or date of the image capture; and/or the presence of obstructions in the line-of-sight of the camera. Generating an updated image may include modifying the captured image and/or the background-image in accordance with the obtained imaging parameters. The modification may include: resizing the user portion relative to the background portion, or vice-versa, and/or repositioning or reorienting the user portion relative to the background portion, or vice-versa. Retrieving the background-image may be performed in accordance with at least one image selection criteria. The camera may be an active imaging gated camera, configured to capture the image at a selected depth of field. The camera may be an active imaging gated camera, configured to capture the image when detecting a retro-reflection from an eye of the user. Obtaining at least a portion of the first set of imaging parameters may include transmitting the imaging parameters over a data communication link to a processor located remotely from the camera. The method may further include the procedures of tracking changes in the first set of imaging parameters and/or the environmental conditions over a sequence of image frames of the captured image, and modifying at least one image frame of the updated image in accordance with the changes in the first set of imaging parameters or environmental conditions. Generating an updated image may include applying at least one image enhancement operation to the captured image or to the background-image. The image enhancement operation may be implemented in accordance with at least one user-defined image fusion criteria.

In accordance with another aspect of the present invention, there is thus provided a system for image augmentation. The system includes at least one camera, a database, and a processor. The camera is configured to capture at least one image of a user in a scene at a first set of imaging parameters, such that the captured image includes a user portion and a background portion with partial scene features cut off at the image frame borders due to limitations of the first set of imaging parameters. The database includes imagery of real-world environments. The processor is communicatively coupled with the camera and with the database. The processor is configured to obtain at least a portion of the first set of imaging parameters, the obtained imaging parameters including at least the position and orientation of the camera when capturing the image. The processor is further configured to retrieve from the database at least one background-image in accordance with the obtained imaging parameters. The retrieved background-image is captured at a second set of imaging parameters different from the first set of imaging parameters, such that the background-image includes supplementary scene features located beyond the image frame borders of the captured image and supplementing information for the partial scene features of the background portion. The processor is further configured to generate an updated image in which the user appears relative to a background that includes at least the supplementary scene features, by image fusion of the captured image with the background-image. The system may further include a location measurement unit configured to detect the position and orientation of the camera when capturing the image. The obtained imaging parameters may further include: physical characteristics of the user; the field of view of the camera; the distance between the camera and the user; the distance between the camera and at least one feature in the scene; the depth of focus of the camera; the focal length of the camera; the f-number of the camera; and/or intrinsic parameters and settings of the camera. The processor may be configured to further obtain environmental conditions of the captured image, and to retrieve the background-image further in accordance with the environmental conditions. The camera may be an active imaging gated camera, configured to capture the image at a selected depth of field. The camera may be an active imaging gated camera, configured to capture the image when detecting a retro-reflection from an eye of the user. The database may include a 3D geographic model that includes a street-level view of a real-world environment. The system may further include a display, configured to display the updated image.

In accordance with a further aspect of the present invention, there is thus provided an adaptive database for augmenting an image of a user in a scene captured at a first set of imaging parameters such that the captured image includes a user portion and a background portion with partial scene features cut off at the image frame borders due to limitations of the first set of imaging parameters. The database includes imagery of real-world environments. A processor coupled to the database is configured to retrieve at least one background-image in accordance with at least a portion of the first set of imaging parameters including at least the position and orientation of the camera when capturing the image. The retrieved background-image is captured at a second set of imaging parameters different from the first set of imaging parameters, such that the background-image includes supplementary scene features located beyond the image frame borders of the captured image and supplementing information for the partial scene features of the background portion. The processor is further configured to generate an updated image in which the user appears relative to a background that includes at least the supplementary scene features, by image fusion of the captured image with the background-image. The database may include a 3D geographic model that includes a street level view of a real-world environment. The database may include at least one user-provided image. The background imagery may include: images associated with a particular location or event; and/or images restricted to particular users or group members. The database may be configured to be updated in accordance with user input. The user input may include: a search query to search through available images in the database; a selection or recommendation of at least one background-image to be retrieved; at least one image selection criteria for retrieving the background-image; metadata to be associated with at least one background-image; at least one image to be uploaded to the database; instructions to modify at least one image in the database; and/or a comment or rating for at least one image in the database or for at least one updated image. The database may be accessible via a Cloud computing network.

### BRIEF DESCRIPTION OF THE DRAWINGS

The present invention will be understood and appreciated more fully from the following detailed description taken in conjunction with the drawings in which:

FIG. 1 is a schematic illustration of a system for augmenting a self-image, constructed and operative in accordance with an embodiment of the present invention;

FIG. 2 is a schematic illustration of an exemplary scenario of taking a self-image, operative in accordance with an embodiment of the present invention;

FIG. 3 is a schematic illustration of the self-image captured in the scenario of FIG. 2, operative in accordance with an embodiment of the present invention;

FIG. 4 is a schematic illustration of a background image associated with the self-image of FIG. 3, operative in accordance with an embodiment of the present invention;

FIG. 5 is a schematic illustration of the self-image of FIG. 3 following an exemplary augmentation using the background image of FIG. 4, operative in accordance with an embodiment of the present invention; and

FIG. 6 is a block diagram of a method for augmenting a self-image, operative in accordance with an embodiment of the present invention.

### DETAILED DESCRIPTION OF THE EMBODIMENTS

The present invention overcomes the disadvantages of the prior art by providing a system and method for augmenting a self-image taken by a user with a camera. The term “self-image” as used herein refers to any image taken by an individual (i.e., a “user”), such as with a hand-held camera or camera phone, in which the image includes at least part of himself/herself, whether or not the individual is actually holding the camera while capturing the image (e.g., by holding the camera at arm's length). For example, a self-image may also be captured when the camera is held by another user or positioned on a nearby surface (e.g., using a self-timer mechanism) or using a fixed camera (e.g., a webcam or a gaming system camera). The augmentation of the self-image involves the addition of relevant background imagery, such as environmental features in the location in which the self-image is acquired, which may not appear in the original self-image. The background imagery is retrieved from an adaptive database that includes a collection of images of different scenes at different geographic locations. The background image is selected using relevant parameters, such as the location, the position and height of the user, the environmental conditions when the self-image was captured, and user-defined image selection criteria. By implementing image fusion and image enhancement operations, an enhanced image is generated that includes the background imagery supplemented with the image portion of the user. The enhanced image may be transmitted or displayed as desired, such as being stored and presented on a camera phone display or uploaded to a website (e.g., through a social networking application).

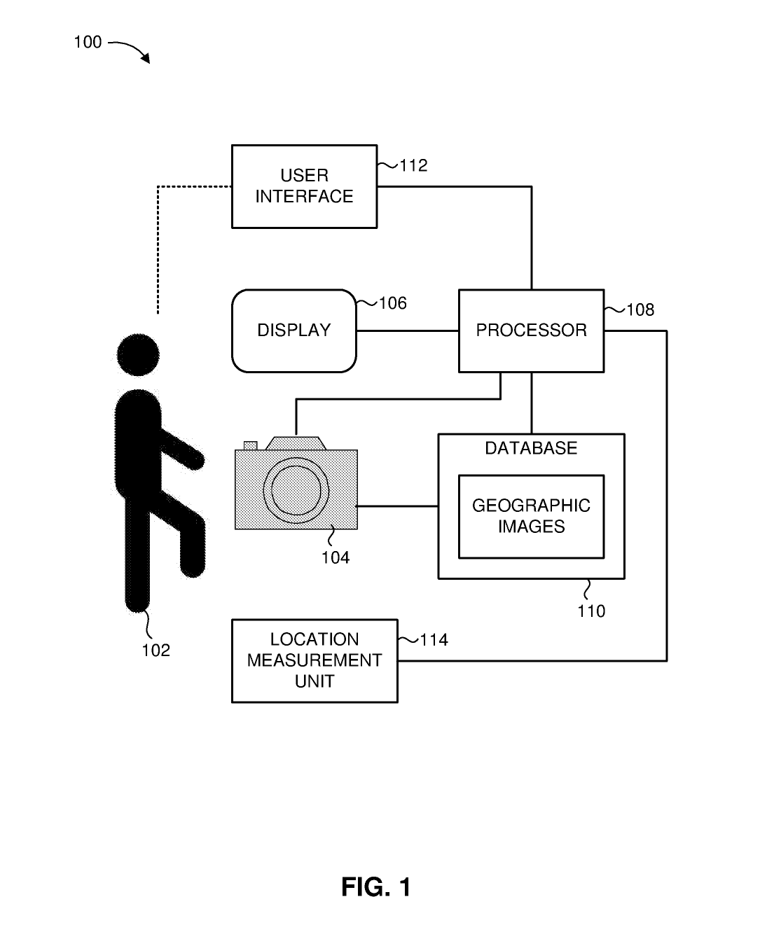

Reference is now made to FIG. 1, which is a schematic illustration of a system, generally referenced 100, for augmenting a self-image, constructed and operative in accordance with an embodiment of the present invention. System 100 includes at least one camera 104, a display 106, a processor 108, a database 110, a user interface 112, and a location measurement unit 114. Processor 108 is communicatively coupled with camera 104, with display 106, with database 110, with user interface 112, and with location measurement unit 114. Camera 104 is further coupled with database 110.

Camera 104 is configured to acquire an image of a real-world scene by a user, referenced 102. Camera 104 may be, for example: a hand-held camera, a camera embedded within a smartphone or other mobile communication device, and/or a camera embedded within a wearable apparatus (e.g., a head-mounted camera). In general, camera 104 may be any type of image sensing device capable of acquiring and storing an image representation of a real-world scene, including the acquisition of any form of electromagnetic radiation at any range of wavelengths (e.g., light in the visible or non-visible spectrum, ultraviolet, infrared, radar, microwave, RF, and the like). Contemporary image sensors are typically semiconductor based, such as charge-coupled devices (CCD), or active-pixel sensors (APS) produced using the complementary metal-oxide-semiconductor (CMOS) or the N-type metal-oxide-semiconductor (N-MOS) processes. Examples of such image sensors include: Intensified-CCD (ICCD)/Intensified-CMOS (ICMOS); Electron Multiplying CCD (EMCCD); Electron Bombarded CMOS (EBCMOS); Hybrid FPA (CCD or CMOS, such as InGaAs, HgCdTe); Avalanche Photo-Diode (APD) focal plane array, Zinc Blende or Sphalerite (e.g. ZnS), Vanadium Oxide (VOx) and Quantum Well infrared Photo-detectors (QWIP). Camera 104 is operative to acquire at least one image frame, such as a sequence of consecutive image frames representing a video image, which may be converted into an electronic signal for subsequent processing and/or transmission. Camera 104 may acquire a 2D image and/or a 3D image (i.e., a depth map). Accordingly, the term “image” as used herein refers to any form of output from an aforementioned image sensor, including any optical or digital representation of a scene acquired at any spectral region, and encompasses both a single image frame and a sequence of image frames (i.e., a “video image”). Camera 104 may be held by user 102, or by another individual when capturing a self-image, or may be positioned onto a fixed or moving platform or surface in the vicinity of user 102 when capturing the self-image. Camera 104 may be a digital camera with adjustable settings, allowing for selecting different parameters and settings to be applied to the captured image, such as: different image capturing modes (e.g., portrait, landscape, motion imaging, night imaging); sensitivity/ISO setting; f-number/aperture size; shutter speed/exposure time; white balance adjustment; optical resolution; zoom/magnification factor; automatic flash illumination; and the like.

Display 106 is configured to display image content to user 102. For example, display 106 may be the display screen of camera 104 or a mobile communication device (e.g., a smartphone or tablet computer) within which camera 104 is embedded. Display 106 may also be embodied by a holographic display or a projected display. Display 106 may be configured with adjustable settings for modifying different parameters relating to the displayed image, such as zooming/panning/rotating the image, and the like.

Location measurement unit (LMU) 114 provides an indication of the real-world location of camera 104 and/or user 102. For example, LMU 114 determines the global position and orientation coordinates of camera 104 with respect to a reference coordinate system. LMU 114 may be embodied by one or more devices or instruments configured to measure the position and orientation of user camera 104, such as: a global positioning system (GPS); a differential global positioning system (DGPS); a compass; an inertial navigation system (INS); an inertial measurement unit (IMU); motion sensors or rotational sensors (e.g., accelerometers, gyroscopes, magnetometers); a rangefinder; and the like. For example, LMU 114 may be a GPS of a mobile communication device (e.g., a smartphone or tablet computer) within which camera 104 is embedded.

Database 110 includes images of different real-world environments. The database images may be continuously updated in real-time. For example, different users of system 100 may be authorized to upload new images to database 110, and/or to delete or modify existing images. Database 110 may include (or be accessible to) existing sets of images of various real-world regions or territories of interest, including artificial features present in those regions (e.g., buildings, monuments, objects, and the like), at a certain point in time. For example, the database images may include a plurality of visual representations of the geographical terrain of a region of interest at different positions and viewing angles, such as acquired via satellite imagery or aerial photography, and/or street level views, such as a 3D model or virtual globe. Database 100 may be embodied by multiple databases (or a single database divided into multiple sections), each containing images respective of a particular geographic location or region. Each database image may be linked to associated data and parameters, such as the location coordinates and the viewing angle of the imaged scene. The images in database 110 may be based on a proprietary and/or publically accessible model (e.g., via open-source platforms), or may include a model that is at least partially private or restricted. Database 110 may alternatively (or additionally) include data from which the images of the real-world environments may be generated, such as using a digital elevation map (DEM). Database 110 may be coupled with camera 104 and/or processor 108 through a data communication channel (not shown), such as a wireless communication link with a suitable wireless network and/or protocol (e.g., wi-fi, cellular, 3G, 4G, LTE, Advanced LTE, etc). System 100 may also include a suitable interface(s) (not shown) for communicatively coupling different components, such as between camera 104 and database 110.

User interface 112 allows user 102, or another user of system 100, to control various parameters or settings associated with the components of system 100. For example, user interface 112 can allow user 102 to enter a search query to search through available background images of a certain location contained in database 110. User interface 112 may also receive from user 102 criteria for selecting certain types of background images, or comments or other feedback relating to an existing background image or an augmented image generated by system 100. User interface 112 may include visual, audio, and/or tactile based interfaces. For example, user interface 112 may include a cursor or touch-screen menu interface, and/or voice recognition capabilities for allowing user 102 to enter instructions or data by means of speech commands.

Processor 108 receives instructions and data from the components of system 100. Processor 108 performs any necessary image processing on the image frames acquired by camera 104 and generates an augmented image, for displaying on display 106. Processor 108 may be situated at a remote location from the other components of system 100. For example, processor 108 may be part of a server, such as a remote computer or remote computing system or machine, which is accessible over a communications medium or network. Alternatively, processor 108 may be situated near user 102 and/or may be integrated within other components of system 100, such as a processor of a mobile communication device (e.g., a smartphone or tablet computer) within which camera 104 is embedded.

The components of system 100 may be based in hardware, software, or combinations thereof. It is appreciated that the functionality associated with each individual component of system 100 may be distributed among multiple components, which may reside at a single location or at multiple locations. For example, the functionality associated with processor 108 may be distributed between multiple processing units (such as a dedicated image processor for the image processing functions). System 100 may optionally include and/or be associated with additional components not shown in FIG. 1, for enabling the implementation of the disclosed subject matter. For example, system 100 may include a power supply (not shown) for providing power to the various components, and may further include an additional memory or storage unit (not shown) for temporary storage of image frames or other types of data.

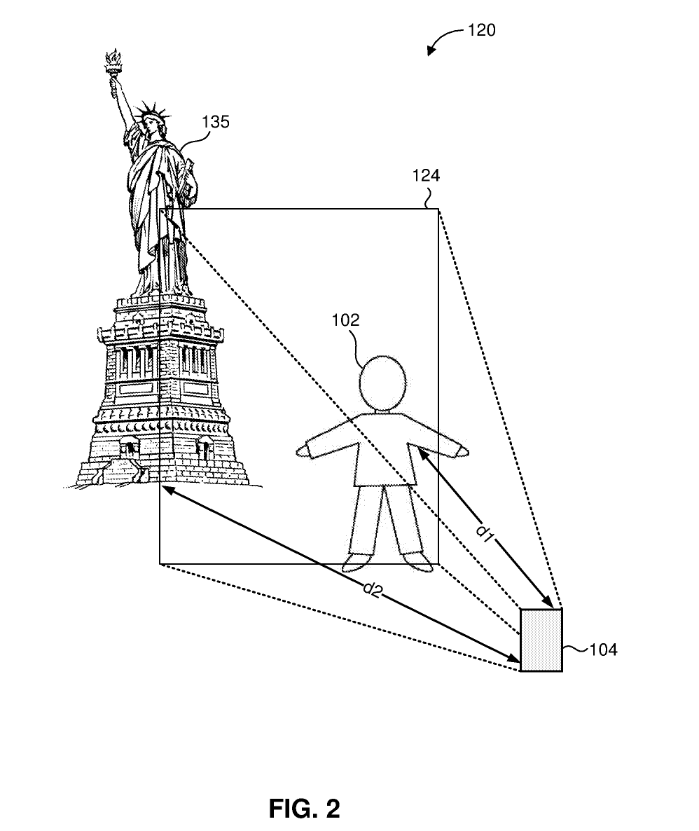

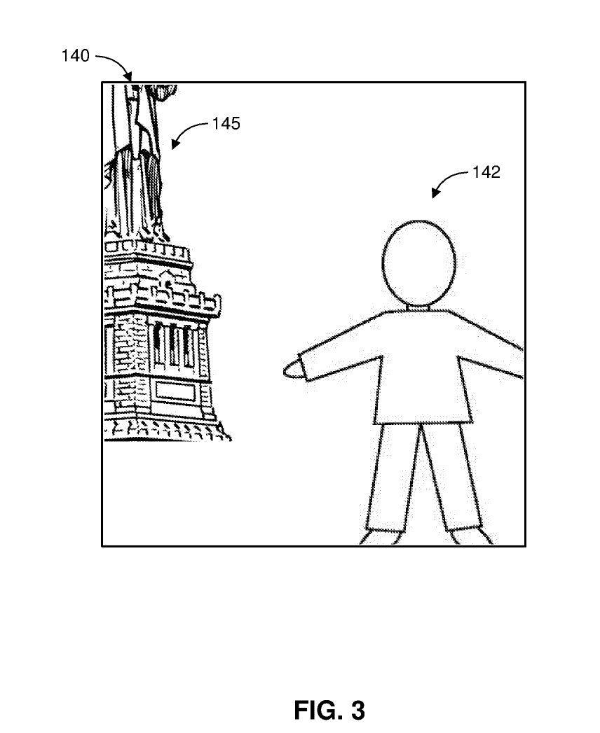

Reference is now made to FIGS. 2 and 3. FIG. 2 is a schematic illustration of an exemplary scenario of taking a self-image, generally referenced 120, operative in accordance with an embodiment of the present invention. FIG. 3 is a schematic illustration of the self-image, referenced 140, captured in the scenario 120 of FIG. 2, operative in accordance with an embodiment of the present invention. User 102 is located at a real-world environment, which is depicted for exemplary purposes as being at the Statue of Liberty in New York Harbor. User 102 captures a self-image 140 with camera 104 next to the Statue of Liberty (referenced 135). Camera 104 is positioned at a first distance (referenced “d1”) relative to user 102, and is positioned at a second distance (referenced “d2”) relative to the Statue 135, where d2 is greater than d1. For example, d1 may be approximately equal to the length of the user's arm (assuming that user 102 captures the self-image while holding camera 104 at arm's length), while d2 may be in the range of tens or hundreds of meters (depending on where user 102 is positioned relative to the Statue 135). Thus, the field of view of camera 104 encompasses a limited portion of both user 102 and the background elements (i.e., Statue 135), represented by the image plane 124 of the captured self-image 140.

Self-image 140 includes a background image portion 145 (e.g., that includes Statue of Liberty 135), as well as a user image portion 142 (e.g., that includes user 102). Due to the nature of the self-image acquisition (e.g., the relative distances and perspective angles at which self-image 140 was captured), both the user image portion 142 and background image portion 145 appears distorted and incomplete. For example, user 102 is partially cropped out and appears too close relative to the Statue 135 (incompatible focal lengths), whereas only a small section of Statue 135 is visible in self-image 140 and it appears hazy and unclear and at a substandard viewing perspective. In general, the quality and characteristics of self-image 140 may be influenced by a variety of different factors, including factors relating to camera 104 and how self-image 140 was captured (e.g., camera position and orientation; distance between camera 104 and user 102; distance between camera 104 and landmarks in the imaged scene; physical characteristics of user 102 such as the length of the user's arm; focal length; optical resolution; ISO setting; f-number; shutter speed; sensitivity; sensor array pixel configuration; and the like), as well as factors relating to the environment in which self-image 140 was captured (e.g., lighting conditions; weather or climate conditions; time of day; month of year or season; presence of obstructions in the line-of-sight of camera 104; and the like). The term “imaging parameters” as used herein encompasses any parameter or characteristic associated with camera 104 and/or with the image acquisition using camera 104, which may influence the characteristics of an acquired self-image. The term “environmental conditions” as used herein encompasses any parameter or characteristic relating to the environment in which a self-image is captured, which may influence the characteristics of that self-image. Accordingly, self-image 140 depicts a limited portion of both user 102 and Statue of Liberty 135 at a certain perspective and quality of appearance, which is at least a function of the imaging parameters of camera 104 and the environmental conditions present during the acquisition of self-image 140.

Self-image 140 may be converted to a digital signal representation of the captured scene, such as in terms of pixel values, which is forwarded to processor 108. The image representation may also be provided to display 106 for displaying the original self-image 140. Processor 108 also receives an indication of imaging parameters and environmental conditions associated with self-image 140. For example, LMU 114 provides the position and orientation of camera 104, such as the location and alignment of camera 104 relative to at least one geographic landmark in the environment, and/or relative to user 102, at the instant that self-image 140 was captured. Accordingly, LMU 114 provides an indication of the particular location at which self-image 140 was captured. Alternatively, user 102 may manually designate the current location (and/or manually designate other imaging parameters or environmental conditions of self-image 140).

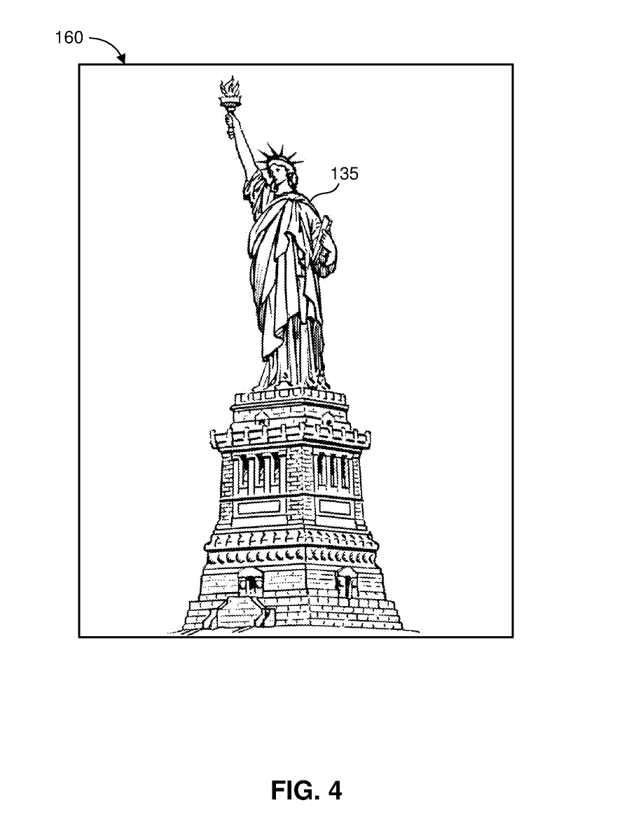

Processor 108 performs initial image processing on self-image 140. In particular, processor 108 at least identifies and extracts a user image portion 142 in self-image 140. Processor 108 may optionally perform initial image enhancement operations on user image portion 142. Processor 108 proceeds to generate an updated image, based on user image portion 142 combined with background imagery associated with self-image 140. In particular, processor 108 retrieves at least one relevant background image from database 110, in accordance with at least the imaging parameters of self-image 140 (e.g., location of self-image 140; orientation, FOV and camera settings of camera 104; height and arm length of user 102; and the like), and in accordance with the environmental conditions relating to self-image 140 (e.g., level of ambient light; weather or climate conditions; time and date; and the like). Processor 108 may also take into account additional criteria when retrieving the background images from database 110. For example, user 102 may manually select or recommend a particular available image of the Statue of Liberty 135, or may designate to use only images that meet certain criteria (e.g., an image taken from a certain angle or perspective; an image that shows at least a certain proportion of Statue 135 or other landmarks in the vicinity; an image that shows only the Statue 135 without any other people present; an image characterized with a “collective user rating” of at least a certain threshold value; an image characterized with only “positive” user feedback; and the like). The image selection criteria may be received by system 100 in real-time via user input (i.e., following the acquisition of self-image 140) or may be predefined (i.e., prior to the acquisition of self-image 140). System 100 may operate under default image selection criteria, which may be defined during a preliminary initialization process, such that system 100 utilizes the default image selection criteria unless instructed otherwise. User 102 may change the image selection criteria in real-time, or may define conditions for altering the image selection criteria automatically. For example, system 100 may be instructed to retrieve background images of a first landmark at a particular geographic location during an initial period of time (or over an initial sequence of image frames), and subsequently retrieve background images of a second landmark at the geographic location during a following period of time (or over a subsequent sequence of image frames). It is noted that a retrieved background image may also include scene features that are located (partially or entirely) outside the field of view of the camera image 140 (i.e., extending beyond the borders of the image frame of camera image 140). Reference is now made to FIG. 4, which is a schematic illustration of a background image, referenced 160, associated with the self-image (140) of FIG. 3, operative in accordance with an embodiment of the present invention. In self-image 140, the Statue of Liberty 135 is cut off and only partially visible as a substantial portion extends beyond the frame borders. This is due to the limited distance between camera 104 and Statue 135 when capturing self-image 140 (which was limited by the arm length of user 102), among other factors such as: the focal length, the depth of focus, and the f-number of camera 104. In contrast, background image 160 was captured at a substantially larger distance relative to Statue 135, as well as a larger focal length and different depth of focus, and as a result depicts the Statue of Liberty 135 in its entirety.

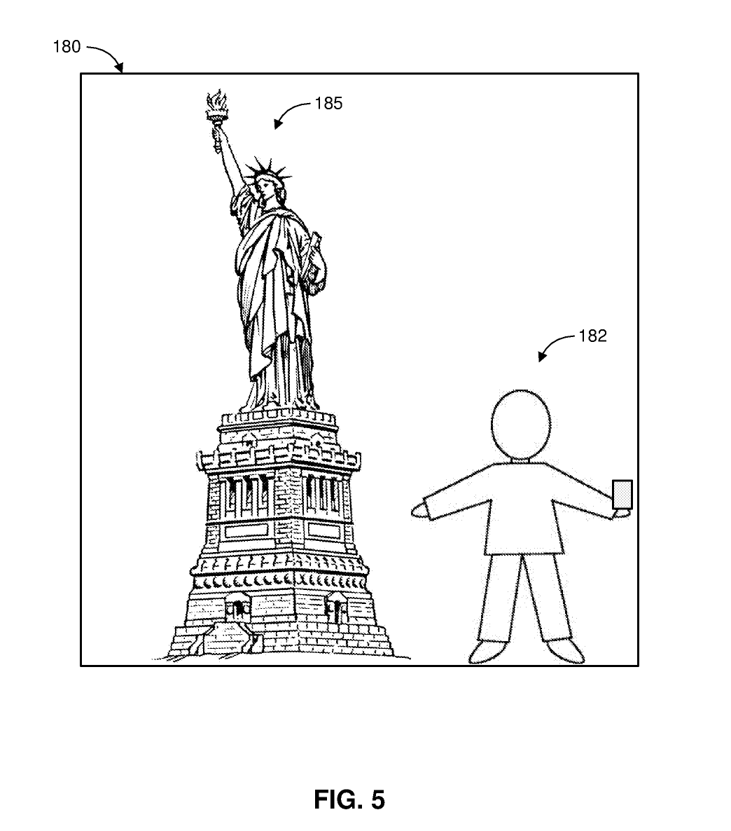

After the relevant background images have been obtained from database 110, processor 108 proceeds to fuse the background images (e.g., image 160) with the user image portion 142 of self-image 140 to generate an updated (augmented) image. Reference is now made to FIG. 5, which is a schematic illustration of the self-image (140) of FIG. 3 following an exemplary augmentation using the background image (160) of FIG. 4, operative in accordance with an embodiment of the present invention. The augmented self-image, generally referenced 180, includes a first image portion 182 that depicts user 102, which is based on the user image portion 142 of the original self-image 140. Image 180 further includes a second image portion 185 that depicts a background environment for the location of self-image 140 (e.g., at Liberty Island in New York Harbor), which is based on background image 160 retrieved by processor 108 from database 110. Processor 108 may utilize image fusion techniques known in the art to merge the user image portion 182 with the background image portion 185 to produce augmented image 180. Processor 108 may optionally perform manipulations and image enhancement operations to at least one of image portions 182, 185, such as to ensure that user image portion 182 appears seamlessly integrated with background image portion 185 on augmented image 180 (e.g., magnification; cropping; white balance adjustment; lighting and color normalization; and the like). Processor 108 may also perform image stabilization operations to compensate for movements or vibrations in camera 104 during the acquisition of self-image 140. Processor 108 may adjust or modify the existing features in the background image retrieved from database 110 so that it will appear best suited with the imaging parameters or environmental conditions associated with self-image 140. For example, processor 108 may resize the user portion in one image relative to the background portion in a second image, or resize the background portion relative to the user portion. Processor 108 may also reposition and/or reorient the user portion relative to the background portion, or reposition and/or reorient the background portion relative to the user portion. For another example, processor 108 may increase (or decrease) the brightness of background image portion 185 such that it substantially matches the brightness level of user image portion 182 (e.g., when fusing a background image captured during the evening with a user image portion of a self-image captured during the morning). Furthermore, processor 108 may combine or stitch together multiple background images, such as to generate a panoramic image or higher-resolution image in augmented image 180. Processor 108 may also take into account user-defined image fusion criteria when implementing the image fusion. For example, user 102 may request that the user image portion 182 be positioned substantially at the center of the augmented image 180, or that the background image portion 185 appear at a selected color pattern or brightness level. User 102 may also provide instructions for modifying characteristics of the user image portion 182, or may manually alter the image portions directly. Once completed, the augmented image 180 may then be displayed on display 106, and/or transmitted to another device or platform (e.g., uploaded to user file storage or uploaded to a social networking application).

System 100 may optionally generate a plurality of augmented images respective of an individual self-image, such as to allow user 102 to view different possible image augmentations and to select a preferred augmented image (or images) from the available options. For example, system 100 may generate different augmented images of self-image 140 corresponding to different views of Statue of Liberty 135 (e.g., from multiple angles, multiple fields of view, and/or multiple zoom/magnification factors; and/or applying different image filters/effects), from which user 102 can then select.

Correspondingly, system 100 may optionally generate a single augmented image respective of a plurality of self-images. For example, camera 104 may acquire multiple self-images (140A, 140B, 140C) similar to self-image 140, such as from different perspectives, focal distances, or fields of view relative to landmarks in the vicinity, or where user 102 is acting or appearing differently in each respective self-image (e.g., having a different expression and/or appearing with different groups of people). For another example, system 100 may obtain multiple self-images of at least one user 102 at a particular location, captured by different cameras 104 (such as by different users) simultaneously or at different times. Processor 108 may then process each of the self-images (140A, 140B, 140C) and select particular image portions from one or more of the self-images, such as based on user-provided or predefined criteria, with which to fuse supplementary background imagery to generate the augmented image 180. Processor 108 may also generate an augmented stereoscopic image 180 from multiple self-images 140A, 140B, 140C of a scene captured by multiple cameras.

System 100 may generate a sequence of augmented image frames (i.e., an augmented video image) corresponding to a sequence of successive self-image frames (i.e., a self-video image) captured by user 102. System 100 may also track changes in the sequence of image frames of a self-video image, and modify the background imagery in the augmented video image accordingly. For example, system 100 may utilize image tracking techniques known in the art to track the location of at least one scene element between image frames, such as the relative locations of user 102 and a particular landmark in the scene (e.g., Statue 135). System 100 may also monitor changes in the appearance of the user image portions and/or background image portions over successive image frames. Processor 108 may then modify the appearance of the user image portions and/or background image portions in an augmented image frame, based on the modified locations and/or modified appearance of each, such as by applying suitable image processing operations. Alternatively, processor 108 may retrieve update background imagery from database 110 to be used for generating the successive image frames of the augmented video image, in accordance with the modified locations/appearance of the user/background image portions in the original self-image frames. For example, processor 108 may modify a user image portion of an earlier frame when generating an augmented image for a later frame, and may then extract an updated user image portion directly from a subsequent frame for augmenting that subsequent frame in order to recalibrate the augmented video image (e.g., to minimize accumulated tracking errors). Further alternatively, processor 108 may incorporate predictions of changes in the user/background image portions in successive frames (e.g., predicted position and orientation coordinates of the user and landmark), to modify their appearance in the respective augmented frame, in accordance with a suitable prediction model.

Processor 108 may optionally add supplementary visual content onto the augmented image 170, such as relevant information relating to an object or region of interest in image 170 (e.g., augmented reality). For example, processor 108 may insert text overlaid onto or adjacent to the Statue of Liberty on image 180, with general information and trivia relating to the Statue of Liberty (e.g., height and weight; dimensions of different components; year of dedication; and the like). Processor 108 may also highlight or otherwise change the appearance of an image portion, such as changing the torch to a different color (e.g., to emphasize a certain region in the environment). In general, the supplementary content may be any type of graphical or visual design, such as: text; images; illustrations; symbology;

geometric designs; highlighting; changing or adding the color, shape, or size of at least one image portion in the image; and the like. Moreover, processor 108 may incorporate audio information into the augmented image 180, such as the presentation of supplemental video imagery or relevant speech announcing or elaborating upon relevant features in the augmented image 180 (e.g., a tour guide explanation of the history of the Statue of Liberty).

According to an embodiment of the present invention, camera 104 may operate using active imaging, in which an image of the scene is generated from accumulated light reflections by a sensor after transmission of light by a light source to illuminate the scene. The light source may be the camera flash illumination, or may be a light emitting diode (LED) or laser based source, e.g., operating in the visible and/or near infrared (NIR) spectrum, emitting continuous wave (CVV) radiation or a series of pulses. Such a camera 104 may further include a gated imaging capability, such that the camera activation is synchronized with the illumination pulses in order to image a particular depth of field (DOF). For example, the camera 104 is activated to accumulate photons when the reflected pulses from a specific distance are due to arrive at the camera, and is deactivated (prevented from accumulated photons) during other time periods. Accordingly, an active imaging gated camera may be employed by system 100 in order to image a selected depth of field, automatically and/or manually. For example, user 102 may want to image only certain environmental features or landmarks which are located at a certain range of distances relative to camera 104, while avoiding the environmental features located at other distances. For example, user 102 may want to selectively image a DOF of between 0.2-12 meters from camera, such that anything closer than 0.2 meters and anything farther than 12 meters away will not be included in the captured self-image. Gated imaging may also be employed to diminish the potential for oversaturation and blooming effects in the captured self-image, by collecting fewer pulses from shorter distances, thereby lowering the overall exposure level of camera 104 to near-field scenery and avoiding high intensity reflections from very close objects. Similarly, the light intensity or the shape of the illumination pulse may be controlled as a function of the distance to the selected landmarks, ensuring that the intensity of the received reflected pulse is at a level that would not lead to overexposure of camera 104. Furthermore, gated imaging may also be used to determine precisely when to capture the self-image or activate the camera. For example, an active imaging gated camera 104 may be configured to be automatically activated (or deactivated) upon detecting a retroreflection from an eye of user 102. The automatic activation may be linked to the DOF, such that, for example, the camera activation is only triggered when the user 102 line-of-sight is aligned directly at the camera and not in other scenarios (such as when user 102 is looking at other people). Such functionality may operate during both daytime (where ambient light might be an issue due to background signal level) and nighttime (where signal to noise might be an issue). Thus, an active imaging gated camera 104 may be characterized with enhanced night vision capabilities, providing a visible image even when there is minimal ambient light present in the environment.

According to an embodiment of the present invention, database 110 is an adaptive and dynamic database, which is continuously updating the collection of images in accordance with new information and changing conditions of the real-world environments. Database 110 may obtain images of real-world environments from different users worldwide, such as of popular tourist locations, where different users may be authorized to upload images directly and/or to modify or delete existing images in database 110. The images provided to database 110 may include metadata (i.e., a “tag”), for assisting identification and classification of the images, and subsequent browsing and searching by different users based on relevant image content. For example, images in database 110 may be categorized and searchable according to different criteria, such as: geographic location of scene; perspective or viewing angle of scene; lighting condition of scene; personal information of user that provided the image; and the like. Accordingly, a user 102 may search database 100 in accordance with selected criteria for particular background images to use for generating augmented image 180, and may manual select the requested images to be used. Processor 108 may also select the optimal background image(s) 160 from database 110 that meets the search criteria (or “image selection criteria”) provided by user 102.

Some of the images in database 110 may be restricted to certain users of system 100, such that only some users have access to view or modify the restricted images or to use the restricted images for augmenting their self-images. For example, users of system 100 may form “groups”, and may provide images to database 110 that are accessible only to members of their user group. Database 110 may also contain images that are available for limited time periods, such as images associated with a particular event or occasion. Accordingly, the database images may also include temporal metadata, indicating the time (and location) of the particular event associated with the image content. For example, images may be uploaded to database 110 of a stadium or arena at which a concert or sporting event is taking place, such that only users who are present at that concert/sporting event may access those images and use them for augmenting their self-images taken during the course of the event.

System 100 may also send out requests to different users to provide images with certain criteria, such as of geographic locations where few (or no) images are currently available in database 110, or images of environments captured at particular angles and/or lighting conditions. Users may provide feedback relating to the images contained in database 110 and/or to augmented images 180 generated by system 100. For example, user feedback may include comments or ratings of different images (e.g., based on a common rating metric), and/or particular recommendations of background images for other users of system 100.

According to an embodiment of the present invention, at least some of the functionality of system 100 may be incorporated into an application program, such as a “mobile app” configured to operate on a mobile computing device (e.g., a smartphone, tablet computer or wearable computer). In particular, at least some of the functions of processor 108 may be implemented via at least one software application installed on a computing device. For example, system 100 may be incorporated into a photo sharing mobile app (such as Instagram™), such as an optional “self-image enhancement tool” within the photo sharing app, allowing the augmented self-image to be shared by user 102 on a social networking platform (e.g., Facebook™, Twitter™, Tumblr™, Flickr™). Accordingly, system 100 may be a computer-implemented system configured to operate in a supporting environment, such as an environment with an available communication network configured to provide for the exchange of data between the respective components of system 100 (e.g., a wired network, a wireless network, a local area network (LAN), a wide area network (WAN), the Internet, a cellular network, and/or any combination thereof). For example, the system of present invention may be implemented using a Cloud computing model, in which information and computing resources are shared and distributed among different systems 100 (and different users 102 of systems 100) over a common network (e.g., the Internet).

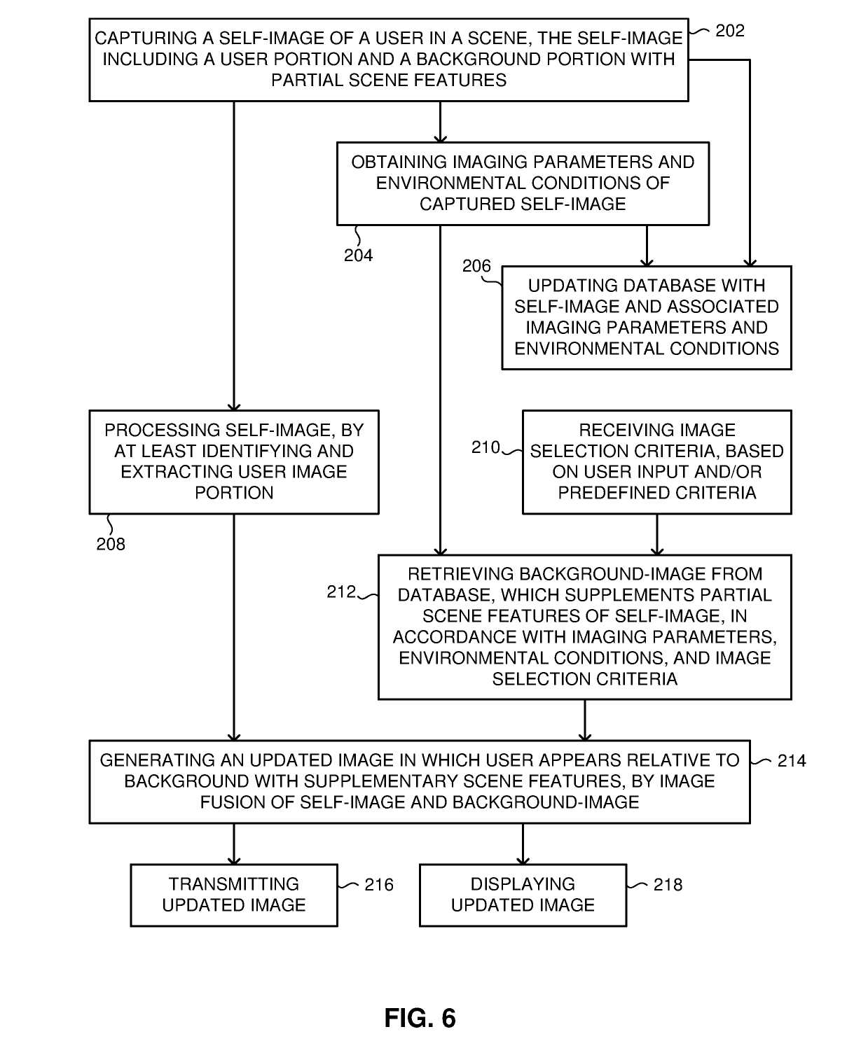

Reference is now made to FIG. 6, which is a block diagram of a method for augmenting a self-image, operative in accordance with an embodiment of the present invention. In procedure 202, a self-image of a user in a scene is captured, the self-image including a user portion and a background portion with partial scene features. Referring to FIGS. 2 and 3, user 102 captures a self-image 140 with camera 104, while standing next to the Statue of Liberty 135. Self-image 140 includes a user image portion 142 showing user 102, and a background image portion 145 showing Statue 135 cut-off and partially visible. A portion of Statue 135 extends beyond the frame borders of self-image 140 due to the limited distance between camera 104 and Statue 135 when capturing self-image 140, as well as additional imaging factors such as the focal length, depth of focus and f-number of camera 104.

In procedure 204, imaging parameters and environmental conditions of the captured self-image are obtained. Referring to FIGS. 1 and 2, processor 108 obtains imaging parameters and environmental conditions associated with self-image 140. At a minimum, processor 108 obtains (e.g., from LMU 114) an indication of the position and orientation of camera 104 when self-image 140 was captured. Processor 108 may also receive other imaging parameters of self-image 140, such as the distance between camera 104 and user 102 (i.e., “d1”) and/or between camera 104 and Statue 135 (i.e., “d2”), or the settings of camera 104 (e.g., focal length, depth of focus, optical resolution, ISO setting, f-number; shutter speed) when capturing self-image 140. Processor 108 may also receive environmental conditions associated with self-image 140, such as the time and date that self-image 140 was captured, the weather and climate conditions when self-image 140 was captured, and the like.

In an optional procedure 206, the database is updated with the self-image and associated imaging parameters and environmental conditions. Referring to FIGS. 1 and 3, self-image 140 is uploaded to database 110, such that database 110 includes the background image portion 145 of the imaged environment (i.e., at the Statue of Liberty 135). The uploaded self-image 140 is linked to the associated imaging parameters and environmental conditions in database 110, to be optionally retrieved and utilized by system 100 when generating a future augmented image of the same environment.

In procedure 208, the self-image is processed by at least identifying and extracting image portions of the user. Referring to FIGS. 1 and 3, processor 108 performs initial processing on self-image 140, including identifying and extracting user image portion 142. Processor 108 may also perform initial image enhancement processing on user image portion 142.

In optional procedure 210, image selection criteria is received, based on user input and/or predefined criteria. Referring to FIGS. 1 and 2, processor 108 obtains image selection criteria, for selecting background images from database 110 (procedure 212). The image selection criteria may be provided by user 102 in real-time (i.e., following the acquisition of self-image 140) or may be predefined (i.e., prior to the acquisition of self-image 140). For example, user 102 may request to manually select a particular background image available in database 110, or may instruct processor 108 to only select background images that meet certain conditions, such as an image that shows Statue of Liberty 135 from a particular viewing perspective, or an image that received a positive feedback or rating.

In procedure 212, a background image which supplements partial scene features of the self-image is retrieved from the database, in accordance with the imaging parameters and environmental conditions and the image selection criteria. Referring to FIGS. 1 and 4, processor 108 retrieves at least one relevant background image 160 from database 110. Background image 160 is selected in accordance with the imaging parameters of self-image 140 (e.g., location of user 102; position and orientation and camera settings of camera 104). Background image 160 is further (optionally) selected in accordance with the environmental conditions relating to self-image 140 (e.g., level of ambient light; weather or climate conditions; time and date), and further (optionally) in accordance with the image selection criteria (e.g., selecting images that show Statue 135 from a particular viewing perspective, selecting images that received a positive feedback or rating). background image 160 depicts Statue 135 in its entirety, including the cut off portion of Statue 135 that does not appear in background image portion 145 of self-image 140. Compared to the imaging parameters of self-image 140, background-image 160 was captured at a substantially larger distance relative to Statue 135, as well as a larger focal length and different depth of focus, and therefore Status of Liberty 135 appears fully and completely in background-image 160.

In procedure 214, an updated image is generated in which the user appears relative to a background with supplementary scene features, by image fusion of the self-image and the background-image. Referring to FIGS. 1 and 5, processor 108 merges the self-image 140 with the background image 160 retrieved from database 110 using image fusion techniques to produce an augmented image 180. Image 180 includes a user image portion 182, corresponding to user image portion 142 of self-image 140, and a background image portion 185 that includes the Statue of Liberty 135 in its entirety (as in background-image 160). The user image portion 182 and background image portion 185 may appear seamlessly integrated, following suitable image enhancement operations. The image fusion may include modifications that take into account the imaging parameters and environmental conditions of self-image 140 and background-image 160 (e.g., resizing, repositioning or reorienting the different image portions relative to one another; adjusting brightness level of different image portions to compensate for different times/dates of image capture). The image fusion and image enhancement operations may further take into account user-defined image fusion criteria, such as instructions that user image portion 182 be at a certain position relative to the landmarks of background image portion 185 in the augmented image 180.

In an optional procedure 216, the updated image is transmitted. Referring to FIGS. 1 and 5, processor 108 transmits augmented image 180 to another device or platform, such as via a data communication channel (not shown), for example by uploading image 180 to a social networking application.

In an optional procedure 218, the updated image is displayed. Referring to FIGS. 1 and 5, processor 108 forwards augmented image 180 to display 106 (e.g., a display screen embedded in a mobile computing device), which displays image 180 to user 102.

It is appreciated that the present invention is generally applicable to any kind of imaging for any purpose and may be employed in a wide variety of applications, such as, for example, industrial, medical, commercial, security, or recreational imaging applications.

While certain embodiments of the disclosed subject matter have been described, so as to enable one of skill in the art to practice the present invention, the preceding description is intended to be exemplary only. It should not be used to limit the scope of the disclosed subject matter, which should be determined by reference to the following claims.

1. A method for image augmentation, the method comprising the procedures of:
capturing at least one image of a user in a scene with at least one camera at a first set of imaging parameters, such that the captured image comprises: a user portion, and a background portion with partial scene features cut off at the image frame borders due to limitations of said first set of imaging parameters;
obtaining at least a portion of said first set of imaging parameters, the obtained imaging parameters comprising at least the position and orientation of said camera when capturing said image;
retrieving at least one background-image in accordance with said obtained imaging parameters, from a database comprising imagery of real-world environments, the retrieved background-image captured at a second set of imaging parameters, different from said first set of imaging parameters, such that said background-image comprises supplementary scene features located beyond the image frame borders of said captured image and supplements said partial scene features of said background portion; and
generating an updated image in which said user appears relative to a background comprising at least said supplementary scene features, by combining said captured image with said background-image.

2. The method of claim 1, further comprising at least one procedure consisting of:
transmitting said updated image; and
displaying said updated image.

3. (canceled)

4. The method of claim 1, wherein said obtained imaging parameters further comprises at least one parameter consisting of:
physical characteristics of said user;
field of view (FOV) of said camera;
distance between said camera and said user;
distance between said camera and at least one feature in said scene;
depth of focus of said camera;
focal length of said camera;
f-number of said camera; and
intrinsic parameters and settings of said camera.

5. The method of claim 1, further comprising the procedure of obtaining environmental conditions of the captured image, wherein said procedure of retrieving at least one background-image comprises retrieving said background-image further in accordance with said environmental conditions.

6. (canceled)

7. The method of claim 1, wherein said procedure of generating an updated image comprises modifying at least one of said captured image; and said background-image, in accordance with said obtained imaging parameters.

8. The method of claim 7, wherein said modifying comprising at least one operation selected from the list consisting of:
resizing said user portion relative to said background portion;
resizing said background portion relative to said user portion;
repositioning or reorienting said user portion relative to said background portion; and
repositioning or reorienting said background portion relative to said user portion.

9. (canceled)

10. The method of claim 1, wherein said procedure of capturing at least one image comprises capturing at least one image of a user with an active imaging gated camera, configured to capture said image at a selected depth of field.

11. The method of claim 1, wherein said procedure of capturing at least one image comprises capturing at least one image with an active imaging gated camera, configured to capture said image when detecting a retro-reflection from an eye of said user.

12. (canceled)

13. The method of claim 5, further comprising the procedures of:
tracking changes in said first set of imaging parameters or said environmental conditions over a sequence of image frames of said captured image; and
modifying at least one image frame of said updated image in accordance with the changes in said first set of imaging parameters or said environmental conditions.

14. The method of claim 1, wherein said camera when capturing said image is positioned at a first distance (d1) relative to said user and positioned at a second distance (d2) relative to a background scene, said first distance (d1) being limited by approximately the arm length of said user and being at least an order of magnitude less than said second distance (d2).

15. (canceled)

16. A system for image augmentation, the system comprising:
at least one camera, configured to capture at least one image of a user in a scene at a first set of imaging parameters, such that the captured image comprises: a user portion, and a background portion with partial scene features cut off at the image frame borders due to limitations of said first set of imaging parameters;
a database, comprising imagery of real-world environments; and
a processor, communicatively coupled with said camera, and with said database, said processor configured to obtain at least a portion of said first set of imaging parameters-, the obtained imaging parameters comprising at least the position and orientation of said camera when capturing said image, said processor further configured to retrieve from said database at least one background-image in accordance with said obtained imaging parameters, the retrieved background-image captured at a second set of imaging parameters, different from said first set of imaging parameters, such that said background-image comprises supplementary scene features located beyond the image frame borders of said captured image and supplements said partial scene features of said background portion, said processor further configured to generate an updated image in which said user appears relative to a background comprising at least said supplementary scene features, by combining said captured image with said background-image.

17. The system of claim 16, further comprising a location measurement unit coupled with said camera and with said processor, said location measurement unit configured to detect the position and orientation of said camera when capturing said image.

18. The system of claim 16, wherein said obtained imaging parameters further comprises at least one parameter consisting of:
physical characteristics of said user;
field of view (FOV) of said camera;
distance between said camera and said user;
distance between said camera and at least one feature in said scene;
depth of focus of said camera;
focal length of said camera;
f-number of said camera; and
intrinsic parameters and settings of said camera.

19. The system of claim 16, wherein said processor is configured to further obtain environmental conditions of said captured image, and to retrieve said background-image further in accordance with said environmental conditions.

20. The system of claim 16, wherein said camera comprises an active imaging gated camera, configured to capture said image at a selected depth of field.

21. The system of claim 16, wherein said camera comprises an active imaging gated camera, configured to capture said image when detecting a retro-reflection from an eye of said user.

22. The system of claim 16, wherein said camera when capturing said image is positioned at a first distance (d1) relative to said user and positioned at a second distance (d2) relative to a background scene, said first distance (d1) being limited by approximately the arm length of said user and being at least an order of magnitude less than said second distance (d2).

23. The system of claim 16, further comprising a display, configured to display said updated image.

24. An adaptive database for augmenting an image of a user in a scene captured at a first set of imaging parameters such that the captured image comprises a user portion and a background portion with partial scene features cut off at the image frame borders due to limitations of said first set of imaging parameters,
the database comprising imagery of real-world environments,
wherein a processor coupled to said database is configured to retrieve at least one background-image, in accordance with at least a portion of said first set of imaging parameters comprising at least the position and orientation of said camera when capturing said image, the retrieved background-image captured at a second set of imaging parameters, different from said first set of imaging parameters, such that said background-image comprises supplementary scene features located beyond the image frame borders of said captured image and supplements said partial scene features of said background portion, said processor further configured to generate an updated image in which said user appears relative to a background comprising at least said supplementary scene features, by combining said captured image with said background-image.

25. (canceled)

26. (canceled)

27. (canceled)

28. The database of claim 24, configured to be updated in accordance with user input.

29. (canceled)

30. (canceled)
